(19) United States
(12) Patent Application Publication
(10) Pub. No.: US 2025/0286084 A1
(43) Pub. Date: Sep. 11, 2025

(54) Fuel Cell Integrated System

(71) Applicant: HYTECH POWER INC., City of Industry, CA (US)

(72) Inventor: Zhengquan Wang, Dalian (CN)

(21) Appl. No.: 18/599,916

(22) Filed: Mar. 8, 2024

(51) Int. Cl. H01M 8/0258; H01M 8/0432; H01M 8/0438; H01M 8/22

(52) U.S. Cl. CPC H01M 8/0258; H01M 8/04358; H01M 8/04365; H01M 8/04417; H01M 8/22; H01M 2200/106

(57) ABSTRACT

A fuel cell integrated system includes a main body having a front side, a rear side, a left side, a right side, a top side, and a bottom side and being supported on a plurality of vertically arranged supporting frames; an inlet and outlet assembly having an air inlet, a cooling liquid inlet, a hydrogen inlet, a hydrogen outlet, a cooling liquid outlet, and a tail gas outlet arranged on the front side of the main body; a fuel cell module communicated with the inlet and outlet assembly and arranged on the right side of the main body; wherein the inlet and outlet assembly comprises a first L shaped supporting panel, a second L-shaped supporting panel attached to the first L-shaped supporting panel to provide a rectangular supporting panel.

### FIELD OF THE DISCLOSURE

The present disclosure relates to a fuel cell integrated system, and more particularly to the fuel cell integrated system having an integrated configuration to reduce the overall volume and size of the fuel cell integrated system and improve the working efficiency for the whole system.

### BACKGROUND OF THE DISCLOSURE

Generally, the hydrogen fuel cell is a device that can directly convert the Gibbs free energy part of hydrogen and oxygen in the air into electric energy. Because it is not limited by the Carnot cycle effect, the reaction temperature is low, and the reaction product is water, the fuel cell has the advantages of eco-friendliness, high efficiency, strong environmental adaptability, fast response speed, and so on.

With the maturity of fuel cell technology, more and more fuel cell power generation devices are applied to commercial vehicles and other transportation fields. Due to the limited layout space of commercial vehicles with a large power demand, the layout and integration of the fuel cell system need to be considered. In particular, the gas distribution, control components, and thermal management devices at the connection end of the fuel cell stack are arranged separately, and in such a layout of the fuel cell system, it may form a large volume and may not be easy for maintenance. At the same time, to ensure the quality of the hydrogen air, the existing design uses an independent filtration device, which occupies a large system space.

Patent application No. 202222040286.9 discloses an integrated design structure for a fuel cell system. Patent application No. 202222040286.9 describes the structural connection design of the system, including the structural design of the system and the connection of functional components, but the controller and core components of the functional components of the system are still installed on the construction beams, which not only occupies the design spaces but also has an impact on the pipeline design, which is not effective to the maintenance and the installation of the system. Therefore, a highly integrated vehicle hydrogen fuel cell power generation device is urgently needed which can integrate the gas distribution components, control components, filtration components, thermal management components, DCF, and other components to reduce system pipeline design, to reduce external wires connections, to support cooling pipeline connections, to improve the volume power density of the system, to reduce the space occupation of the system, and to improve the maintainability of the system.

All referenced patents, applications and literature are incorporated herein by reference in their entirety. Furthermore, where a definition or use of a term in a reference, which is incorporated by reference herein, is inconsistent or contrary to the definition of that term provided herein, the definition of that term provided herein applies and the definition of that term in the reference does not apply. The disclosed embodiments may seek to satisfy one or more of the above-mentioned desires. Although the present embodiments may obviate one or more of the above-mentioned desires, it should be understood that some aspects of the embodiments might not necessarily obviate them.

### BRIEF SUMMARY OF THE DISCLOSURE

In a general implementation, a fuel cell integrated system may comprise a main body having a front side, a rear side, a left side, a right side, a top side, and a bottom side being supported on a plurality of vertically arranged supporting frames; an inlet and outlet assembly having an air inlet, a cooling liquid inlet, a hydrogen inlet, a hydrogen outlet, a cooling liquid outlet, and a tail gas outlet arranged on the front side of the main body; a fuel cell module communicated with the inlet and outlet assembly and arranged on the right side of the main body; wherein the inlet and outlet assembly comprises a first L-shaped supporting panel and a second L-shaped supporting panel attached to the first L-shaped supporting panel to provide a rectangular supporting panel; wherein the air inlet, the cooling liquid inlet, and the hydrogen outlet are formed on the first L-shaped supporting panel; wherein the hydrogen inlet, the cooling liquid outlet, and a tail gas outlet are formed on the second L-shaped supporting panel.

In another aspect combinable with the general implementation, the fuel cell integrated system may comprise a fuel cell controller and a low-pressure box arranged on the rear side of the main body, wherein the front side of the main body is opposite of the rear side of the main body.

Further, it is contemplated that the first L-shaped supporting panel comprises an air inlet panel affixed on the first L-shaped supporting panel, a cooling liquid inlet affixed on the first L-shaped supporting panel, and a hydrogen outlet panel affixed on the first L-shaped supporting panel, wherein the air inlet panel, the cooling liquid inlet panel, and the hydrogen outlet panel are separately and spacedly arranged with each other.

In the alternative, the first L-shaped supporting panel comprises an air inlet panel where the air inlet is formed thereon, an air inlet distribution head attached to the air inlet of the air inlet panel, an air inlet temperature sensor integrated with the air inlet distribution head, an air inlet throttle integrated with the air inlet distribution head, an air inlet switchboard detachably coupled to the air inlet distribution head, and an air inlet filter integrated with the air inlet switchboard, and an air inlet pressure sensor integrated with the air inlet distribution head.

It is still further contemplated that the first L-shaped supporting panel comprises a cooling liquid inlet panel where the cooling liquid inlet is formed thereon, a cooling liquid distribution head attached to the cooling liquid inlet of the cooling liquid inlet panel, a cooling liquid inlet temperature sensor integrated with the cooling liquid distribution head, a cooling liquid inlet switchboard detachably coupled with the cooling liquid inlet distribution head, and a cooling liquid inlet filter affixed with the cooling liquid switchboard.

In another aspect combinable with the general implementation, the first L-shaped supporting panel comprises a hydrogen outlet panel where the hydrogen outlet is formed thereon, a water vapor separator integrated with the hydrogen outlet of the hydrogen outlet panel, and a hydrogen outlet pressure sensor integrated with the water vapor separator.

In another aspect combinable with the general implementation, the second L-shaped supporting panel comprises a hydrogen inlet and cooling liquid outlet panel affixed on the second L-shaped supporting panel, and a tail gas outlet panel affixed on the second L-shaped supporting panel and contacted with the hydrogen inlet and cooling liquid outlet panel.

In another aspect combinable with the general implementation, the second L-shaped supporting panel comprises a hydrogen inlet and cooling liquid outlet panel where the hydrogen inlet and the cooling liquid outlet are formed thereon, a hydrogen inlet distribution head attached to the hydrogen inlet of the hydrogen inlet and cooling liquid outlet panel, a hydrogen inlet temperature sensor integrated with the hydrogen inlet distribution head, a hydrogen inlet filter detachably coupled with the hydrogen inlet distribution head, and a hydrogen inlet pressure sensor integrated with the hydrogen inlet temperature sensor.

In another aspect combinable with the general implementation, the second L-shaped supporting panel comprises a hydrogen inlet and cooling liquid outlet panel, a thermostat integrated with the cooling liquid outlet formed on the hydrogen inlet and cooling liquid outlet panel, a cooling liquid outlet pressure sensor integrated with the cooling liquid outlet formed on the hydrogen inlet and cooling liquid outlet panel, and a cooling liquid outlet temperature sensor integrated with the cooling liquid outlet formed on the hydrogen inlet and cooling liquid outlet panel.

In another aspect combinable with the general implementation, the second L-shaped supporting panel comprises a tail gas outlet panel, the tail gas outlet arranged on the tail gas outlet panel, a tail gas throttle integrated with the tail gas outlet, and a tail gas outlet tube coupled with the tail gas throttle in a flange connection.

In another aspect combinable with the general implementation, the fuel cell integrated system may further comprise a hydrogen recirculation ejector assembly arranged on the front side of the main body and communicated with the inlet and outlet assembly, wherein the hydrogen recirculation ejector assembly comprises an ejector, a fuel cell hydrogen inlet communicated with the ejector, a secure valve and a proportional valve communicated with ejector.

In another aspect combinable with the general implementation, the fuel cell integrated system may further comprise a hydrogen buffer valve assembly arranged on the bottom side of the main body, and a hydrogen recycle pump arranged on the top side of the main body, wherein the bottom side of the main body is opposite of the top side of the main body, wherein the hydrogen buffer valve comprises a buffer tank having a buffer tank left side and a buffer tank right side opposite of the buffer tank left side, a buffer purge valve communicated with the buffer tank and arranged on the buffer tank left side, and a purge valve communicated with the buffer tank and arranged on the buffer tank right side.

In another aspect combinable with the general implementation, the fuel cell integrated system may further comprise an air compressor arranged on the bottom side of the main body, an intercooler communicated with the air compressor and arranged on the bottom side of the main body, and a plurality of fourth transmission tubes communicated with the air compressor, the intercooler, and the inlet and outlet assembly, wherein the fourth transmission tubes are extended from the left side of the main body to provide a fuel-air source to the fuel cell module.

In another aspect combinable with the general implementation, the fuel cell integrated system may further comprise a water pump arranged on the bottom side of the main body, a PTC heater arranged on the bottom side of the main body, and a DC/DC converter for the fuel cell module arranged on the top side of the main body.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above and below as acting in certain combinations and even initially claimed as such, one or more features from a claimed combination can in some cases be excised from the combination, and the claimed combination may be directed to a subcombination or variation of a subcombination.

A number of implementations have been described. Nevertheless, it will be understood that various modifications may be made without departing from the spirit and scope of the disclosure. For example, example operations, methods, or processes described herein may include more steps or fewer steps than those described. Further, the steps in such example operations, methods, or processes may be performed in different successions than that described or illustrated in the figures. Accordingly, other implementations are within the scope of the following claims.

The details of one or more implementations of the subject matter described in this disclosure are set forth in the accompanying drawings and the description below. Other features, aspects, and advantages of the subject matter will become apparent from the description, the drawings, and the claims.

### BRIEF DESCRIPTION OF THE DRAWINGS

It should be noted that the drawing figures may be in simplified form and might not be too precise scale. In reference to the disclosure herein, for purposes of convenience and clarity only, directional terms such as top, bottom, left, right, up, down, over, above, below, beneath, rear, front, distal, and proximal are used with respect to the accompanying drawings. Such directional terms should not be construed to limit the scope of the embodiment in any manner.

FIG. 1 is a front and left view of the fuel cell integrated system according to an aspect of the embodiments.

FIG. 2 is a front and right view of the fuel cell integrated system according to an aspect of the embodiments.

FIG. 3 is a left and rear view of the fuel cell integrated system according to an aspect of the embodiments.

FIG. 4 is a top view of one side of the inlet and outlet assembly according to an aspect of the embodiments.

FIG. 5 is a top view of the opposite side of the inlet and outlet assembly as shown in FIG. 4 according to an aspect of the embodiments.

### DETAILED DESCRIPTION OF THE EMBODIMENTS

The different aspects of the various embodiments can now be better understood by turning to the following detailed description of the embodiments, which are presented as illustrated examples of the embodiments defined in the claims. It is expressly understood that the embodiments as defined by the claims may be broader than the illustrated embodiments described below.

The term “a” or “an” entity refers to one or more of that entity. As such, the terms “a” (or “an”), “one or more” and “at least one” can be used interchangeably herein. It is also to be noted that the terms “comprising,” “including,” and “having” can be used interchangeably.

It shall be understood that the term “means,” as used herein, shall be given its broadest possible interpretation in accordance with 35 U.S.C., Section 112 (f). Accordingly, a claim incorporating the term “means” shall cover all structures, materials, or acts set forth herein, and all of the equivalents thereof. Further, the structures, materials or acts and the equivalents thereof shall include all those described in the summary of the invention, brief description of the drawings, detailed description, abstract, and claims themselves.

Unless defined otherwise, all technical and position terms used herein have the same meaning as commonly understood by one of ordinary skill in the art to which the invention pertains. Although many methods and materials similar to, modified to, or equivalent to those described herein can be used in the practice of the present invention without undue experimentation, the preferred materials and methods are described herein. In describing and claiming the present invention, the following terminology will be used in accordance with the definitions set out below.

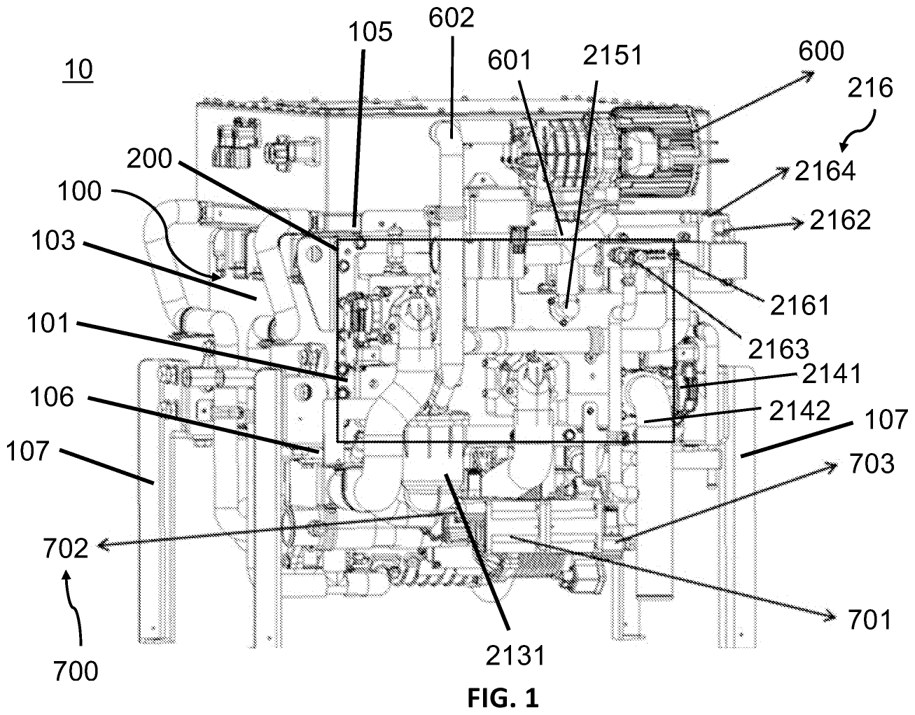

FIG. 1 to FIG. 3 generally depict a fuel cell integrated system 10 according to an aspect of the embodiments.

Referring to FIGS. 1-3 of the drawings, the fuel cell integrated system 10 may comprise a main body 100 having a front side 101, a rear side 102, a left side 103, a right side 104, a top side 105, and a bottom side 106 being supported on a plurality of vertically arranged supporting frames 107, wherein the front side 101 may be opposite of the rear side 102, and the left side 103 may be opposite of the right side 102, and the top side 105 may be opposite of the bottom side 106.

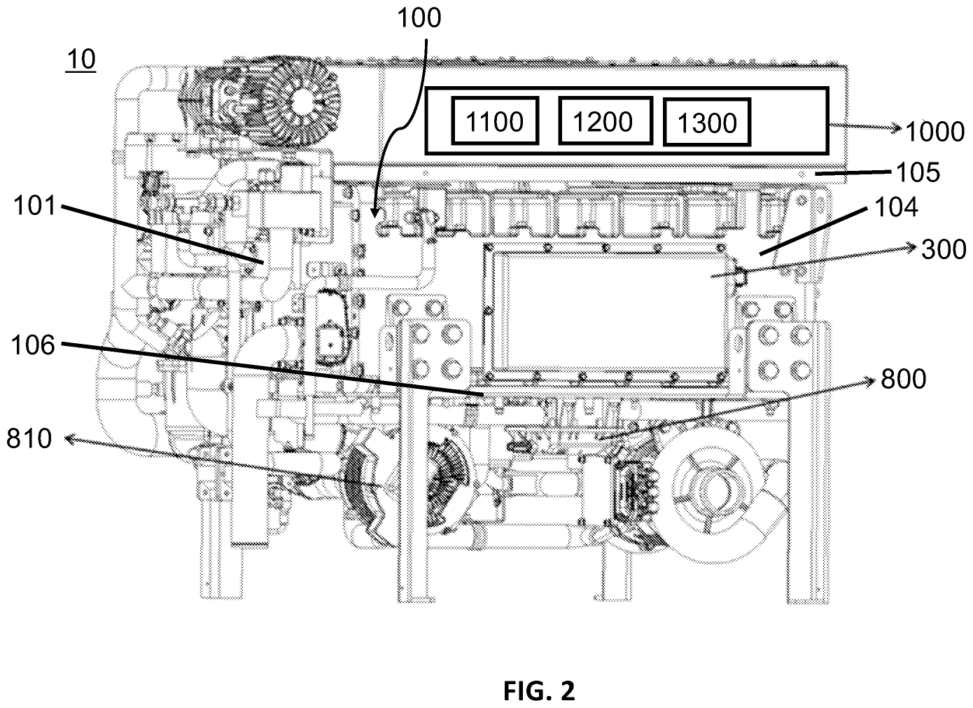

Continuing to FIGS. 1-2, in some embodiments, the fuel cell integrated system 10 may further comprise an inlet and outlet assembly 200 arranged on the front side 101 of the main body 100, and a fuel cell module 300 communicated with the inlet and outlet assembly 200 and arranged on the right side 104 of the main body 100.

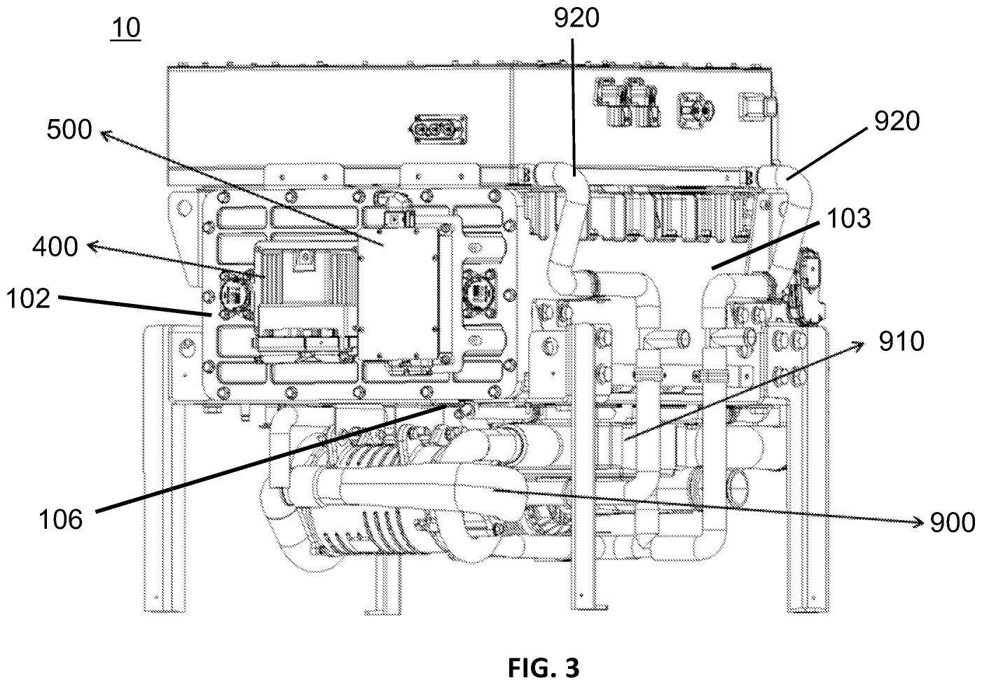

In still some embodiments, as shown in FIG. 3, the fuel cell integrated system 10 may further comprise a fuel cell controller 400 and a low-pressure box 500 arranged on the rear side 102 of the main body 100.

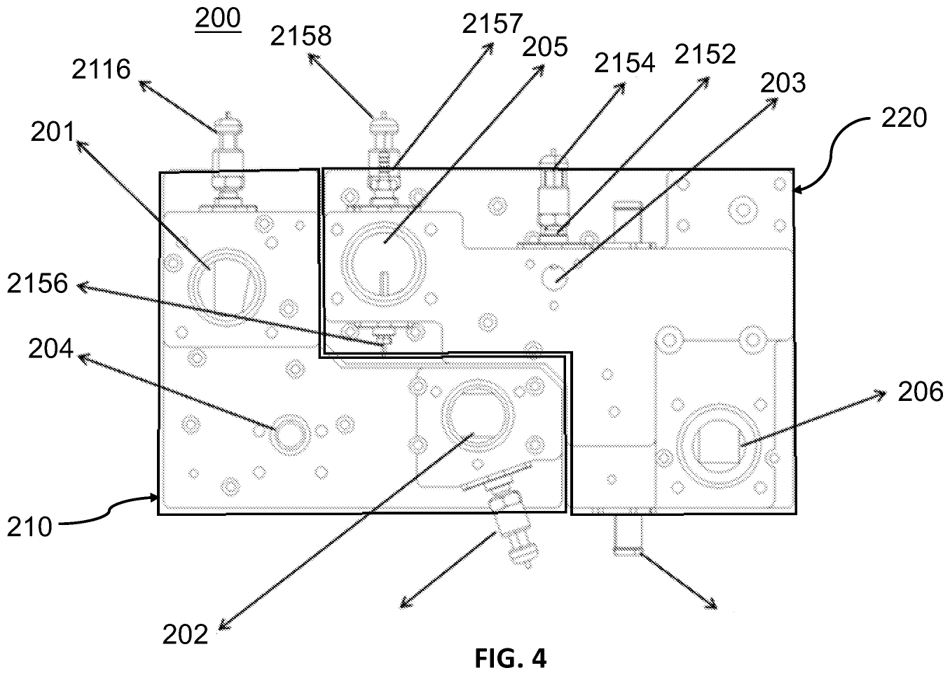

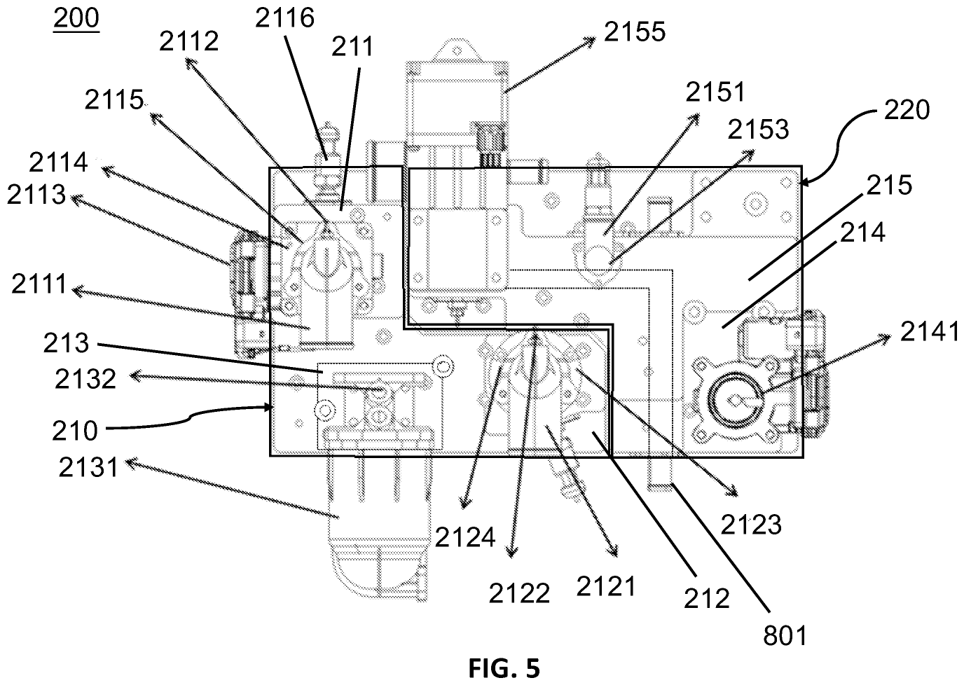

FIG. 4 generally depicts one side of a top view of the inlet and outlet assembly 200 according to an aspect of the embodiments. FIG. 5 generally depicts an opposite side of the one side of the top view of the inlet and outlet assembly 200 according to an aspect of the embodiments.

As shown in FIG. 4, the inlet and outlet assembly 200 may comprise an air inlet 201 configured to provide air to the fuel cell module, a cooling liquid inlet 202 configured to provide cooling liquid to the fuel cell module, a hydrogen inlet 203 configured to provide hydrogen to the fuel cell module, a hydrogen outlet 204 configured to emit unreacted hydrogen from the fuel cell module, a cooling liquid outlet 205 configured to emit liquid discharges from the fuel cell module, and a tail gas outlet 206 configured to emit gas discharges from the fuel cell module, wherein the air inlet 201, the cooling liquid inlet 202, the hydrogen inlet 203, the hydrogen outlet 204, the cooling liquid outlet 205, and the tail gas outlet 206 may be spacedly arranged with each other.

In some embodiments, the inlet and outlet assembly 200 may comprise a first L-shaped supporting panel 210, and a second L-shaped supporting panel 220 attached to the first L-shaped supporting panel 210 to provide a rectangular supporting panel, wherein the air inlet 201, the cooling liquid inlet 202, and the hydrogen outlet 204 are formed on the first L-shaped supporting panel 210, wherein the hydrogen inlet 203, the cooling liquid outlet 205, and a tail gas outlet 206 are formed on the second L-shaped supporting panel 220.

As shown in FIG. 5, the first L-shaped supporting panel 210 may comprise an air inlet panel 211 affixed on the first L-shaped supporting panel 210, a cooling liquid inlet panel 212 affixed on the first L-shaped supporting panel 210, and a hydrogen outlet panel 213 affixed on the first L-shaped supporting panel 210, wherein the air inlet panel 211, the cooling liquid inlet panel 212, and the hydrogen outlet panel 213 are separately and spacedly arranged with each other.

Continuing to FIGS. 4-5, the first L-shaped supporting panel 210 may comprise the air inlet panel 211, an air inlet distribution head 2111 attached on the air inlet panel 211 and aligned with the air inlet 201 to allow air entered into the fuel cell module, an air inlet temperature sensor 2112 integrated with the air inlet distribution head 2111, an air inlet throttle 2113 integrated with the air inlet distribution head 2111, an air inlet switchboard 2114 detachably coupled with the air inlet distribution head 2111, an air inlet filter 2115 affixed with the air inlet switchboard 2114, and an air inlet pressure sensor 2116 integrated with the air inlet distribution head 2111; therefore, the air inlet panel 211 may be configured to integrate the air inlet distribution head 2111, the air inlet throttle 2113, the air inlet switchboard 2114, the air inlet filter 2115, the air inlet temperature sensor 2112, and the air inlet pressure sensor 2116, and in such a way, the air inlet throttle 2113, the air inlet switchboard 2114, the air inlet filter 2115, the air inlet temperature sensor 2112, and the air inlet pressure sensor 2116 may be arranged adjacent to each other in order to not only save the overall size of the fuel cell integrated system, but also to facilitate the technician to maintain the fuel cell integrated system. In some embodiment, since the air inlet switchboard 2114 is detachably coupled with the air inlet distribution head 2111, and the air inlet filter 2115 is affixed to the air inlet switchboard 2114, while the technician is replacing the air inlet filter 2115, the air inlet switchboard 2114 may be detached for replacing the air inlet filter 2115, instead of detaching the air inlet distribution head 2111.

It should be noted that the air inlet distribution head 2111 may be aligned with the air inlet 201, and in such a way, the air inlet 201 may be a through hole passing through the first L-shaped supporting panel 210 and the air inlet panel 211; therefore, the air may be entered into the fuel cell module through the air inlet 201.

In still some embodiments, the air inlet throttle 2113 is automatically turned off or turned on based on the operation of the fuel cell module. While the fuel cell module is under operation, the air inlet throttle 2113 is not operated to allow the air to enter the fuel cell module; in other words, while the fuel cell module is not operated, the air inlet throttle 2113 is operated to close the air inlet 201 for preventing outside air, including dust particles within the air, entering into the fuel cell module, in order to stabilize the operation and prolong the lifespan of the fuel cell module.

In still some embodiments, the mesh number of the air inlet filter 2115 may be 300 mesh, and in this situation, the air particles entered into the fuel cell module may be less than 48 μm to provide a stable and safe working performance of the fuel cell module.

In still some embodiments, the air inlet switchboard 2114 may be made of stainless steel which can prevent the rust caused by the moisture generated from the operation of the fuel cell module.

As shown in further details in FIG. 5, the first L-shaped supporting panel 210 may comprise the cooling liquid inlet panel 212, a cooling liquid distribution head 2121 attached to the cooling liquid inlet panel 212, a cooling liquid inlet temperature sensor 2122 integrated with the cooling liquid distribution head, a cooling liquid inlet switchboard 2123 detachably coupled to the cooling liquid inlet distribution head 2121, and a cooling liquid inlet filter 2124 affixed/coupled with the cooling liquid switchboard 2123.

In some embodiment, since the cooling liquid switchboard 2123 is detachably coupled with the cooling liquid distribution head 2121, and the cooling liquid filter 2124 is affixed/coupled to the cooling liquid switchboard 2123, while the technician is replacing the cooling liquid filter 2124, the cooling liquid switchboard 2123 may be detached for replacing the cooling liquid filter 2124, instead of detaching the cooling liquid distribution head 2121.

It should be noted that the cooling liquid distribution head 2121 may be aligned with the cooling liquid inlet 202, and in such a way, the cooling liquid inlet 202 may be a through hole passed through the first L-shaped supporting panel 210 and the cooling liquid panel 212; therefore, the cooling liquid may be entered into the fuel cell module through the cooling liquid inlet 202.

In some embodiments, the cooling liquid inlet filter 2124 may be 100-mesh, and in such a way, the cooling liquid particles entered into the fuel cell module may be less than 0.15 mm to provide a stable and safe working performance of the fuel cell module.

In still some embodiments, the cooling liquid inlet switchboard 2123 may be made of stainless steel which can prevent the rust caused by the moisture generated from the operation of the fuel cell module.

As shown in FIG. 5, in some embodiments, the first L-shaped supporting panel 210 may comprise a hydrogen outlet panel 213 where the hydrogen outlet 204 is formed thereon, a water vapor separator 2131 integrated with the hydrogen outlet panel 213, and a hydrogen outlet pressure sensor 2132 integrated with the water vapor separator 2131, and in such a way, the hydrogen outlet 204 may be a through hole passed through the first L-shaped supporting panel 210 and the hydrogen outlet panel 213.

As shown in further details in FIG. 1, FIG. 4, and FIG. 5, the second L-shaped supporting panel 220 may comprise a tail gas outlet panel 214, the tail gas outlet 206 arranged on the tail gas outlet panel 214, a tail gas throttle 2141 integrated with the tail gas outlet 206, and a tail gas outlet tube 2142 coupled with the tail gas throttle 2141 in a flange connection.

In still some embodiments, the fuel cell integrated system 10 may further comprise a hydrogen buffer valve assembly 700 arranged on the bottom side 106 of the main body 100 and a hydrogen recycle pump 600 arranged on the top side 105 of the main body 100, wherein the hydrogen buffer valve assembly 700 may comprise a buffer tank 701 having a buffer tank right side and a buffer tank left side, wherein the buffer tank right side is opposite of the buffer tank left side, wherein the hydrogen buffer valve assembly 700 may comprise a buffer purge valve 702 communicated with the buffer tank 701 and arranged on the buffer tank left side of the buffer tank 701, and a purge valve 703 communicated with the buffer tank 701 and arranged on the buffer tank right side of the buffer tank 701. In such a way, the hydrogen buffer valve assembly 700 may cooperate with the fuel cell module; in other words, the hydrogen buffer valve assembly 700 may stabilize the hydrogen pressure and the amount of hydrogen entering into the fuel cell module to stabilize the operation of the fuel cell module.

Referring to FIG. 4 of the drawings, the second L-shaped supporting panel 220 may comprise the hydrogen inlet and cooling liquid outlet panel 215 affixed on the second L-shaped supporting panel 220, and the tail gas outlet panel 214 affixed on the second L-shaped supporting panel 220 and contacted with the hydrogen inlet and cooling liquid outlet panel 215. In some embodiments, the second L-shaped supporting panel 220 may comprise a hydrogen inlet distribution head 2151 attached to the hydrogen inlet and cooling liquid outlet panel 215, a hydrogen inlet temperature sensor 2152 integrated with the hydrogen inlet distribution head 2151, a hydrogen inlet filter 2153 detachably coupled with the hydrogen inlet distribution head 2151, and a hydrogen inlet pressure sensor 2154 integrated with the hydrogen inlet temperature sensor 2152.

It should be noted that, continuing to FIGS. 4-5, in some embodiments, the hydrogen inlet distribution head 2151 may be aligned with the hydrogen inlet 203, and in such a way, the hydrogen inlet 203 may be a through hole passing through the second L-shaped supporting panel 220 and the hydrogen inlet and cooling liquid outlet panel 215; therefore, the hydrogen may be entered into the fuel cell module through the hydrogen inlet 203.

Referring to FIG. 5, in some embodiments, the second L-shaped supporting panel 220 may comprise the hydrogen inlet and cooling liquid outlet panel 215 where the cooling liquid outlet 205 is formed thereon, a thermostat 2155 integrated with the cooling liquid outlet 205 arranged on the hydrogen inlet and cooling liquid outlet panel 215, a cooling liquid outlet pressure sensor 2158 integrated with the cooling liquid outlet 205 arranged on the hydrogen inlet and cooling liquid outlet panel 215, a cooling liquid purge hole 2157 integrated with a cooling liquid outlet pressure sensor 2158, and a cooling liquid outlet temperature sensor 2156 integrated with the cooling liquid outlet 205 arranged on the hydrogen inlet and cooling liquid outlet panel 215, and in such a way, the cooling liquid outlet 205 may be a through hole passing through the second L-shaped supporting panel 220 and the hydrogen inlet and cooling liquid outlet panel 215.

It should be noted that, as shown in FIG. 2 and FIG. 5, the fuel cell integrated system May 10 further comprise a PTC (positive temperature coefficient) heater 800 arranged on the bottom side 106 of the main body 100, wherein the thermostat 2155 may be communicated with the PTC heater 800 through a first transmission tube 801, wherein the first transmission 801 tube may be arranged underneath the inlet and outlet assembly 200 and arranged across the inlet and outlet assembly 200 to communicate the thermostat 2155 arranged on the front side 101 of the main body 100 and the PTC heater 800 arranged on the bottom side 106 of the main body 100.

Referring back to FIG. 1, the fuel cell integrated system 10 may further comprise a hydrogen recirculation ejector assembly 216 arranged on the front side 101 of the main body 100, wherein the hydrogen recirculation ejection assembly 216 may be communicated with the inlet and outlet assembly 200 (communicated with the hydrogen inlet distribution head 2151), wherein the hydrogen recirculation ejector assembly 216 comprises an ejector 2161, a fuel cell hydrogen inlet 2162 communicated with the ejector 2161 and the fuel cell module, a secure valve 2163 communicated with the ejector 2161, and a proportional valve 2164 communicated with ejector 2161, wherein the ejector 2161 may be communicated with the hydrogen recycle pump 600 through a second transmission tube 601, and in such a way, the ejector 2161 may be configured to guide the hydrogen generated from the operation of the fuel cell module and transmit back to the fuel cell module through the fuel cell hydrogen inlet 2162.

Continuing to FIG. 1, the hydrogen recycle pump 600 may be communicated with the fuel cell hydrogen inlet 2162 through the second transmission tube 601 and the water vapor separator 2131 through a third transmission tube 602, wherein the third transmission tube 602 may be extended from the top side 105 of the main body 100 to the front side 101 of the main body, and in such a way, the unreacted hydrogen from the fuel cell module may be transmitted back to the hydrogen recycle pump 600 and reentered into the fuel cell module through the fuel cell hydrogen inlet 2162. For example, in some embodiments, the water vapor separator 2131 may be integrated with the hydrogen outlet 204 formed on the hydrogen outlet panel 213. In such a way, the discharges emitted from the hydrogen outlet 204 from the fuel cell module may be processed by the water vapor separator 2131 to separate the hydrogen and the water from the discharges. The hydrogen may be transmitted back to the hydrogen recycle pump 600 through the third transmission tube 602 and reentered into the fuel cell module through the fuel cell hydrogen inlet 2162.

Referring back to FIG. 3 of the drawings, the fuel cell integrated system 10 may further comprise an air compressor 900 arranged on the bottom side 106 of the main body 100, an intercooler 910 communicated with the air compressor 900 and arranged on the bottom side 106 of the main body 100, and a plurality of fourth transmission tubes 920 communicated with the air compressor 900, the intercooler 910, and the inlet and outlet assembly 200 (see FIG. 1), wherein the fourth transmission tubes 920 may be extended from the left side 103 of the main body 100 to provide a fuel source to the fuel cell module.

Referring back to FIG. 2 and FIG. 5, the fuel cell integrated system 10 may further comprise a water pump 810 arranged on the bottom side 106 of the main body 100, wherein the water pump 810 may be communicated with the cooling liquid inlet distribution head 2121 for providing the cooling liquid to the fuel cell module.

Continuing to FIG. 2, The fuel cell integrated system 10 may further comprise a controller assembly 1000 arranged on the top side 105 of the main body 100, wherein the controller assembly 1000 may comprise a DC/DC converter for the fuel cell module 1100, a controller for the hydrogen recycle pump 1200, and a controller for the air compressor 1300, wherein all the controllers (the DC/DC converter for the fuel cell module 1100, the controller for the hydrogen recycle pump 1200, and the controller for the air compressor 1300) are integrated on the top side 105 of the main body 100 to reduce the overall volume and size of the fuel cell integrated system.

According to the configuration of all the components of the fuel cell integrated system 10 as mentioned above, the dimensions of the fuel cell integrated system 10 may be 990 mm*706 mm*717 mm, and the overall volume of the fuel cell integrated system may be 0.51 m³.

Many alterations and modifications may be made by those having ordinary skill in the art without departing from the spirit and scope of the disclosed embodiments. Therefore, it must be understood that the illustrated embodiments have been set forth only for the purposes of example and that it should not be taken as limiting the embodiments as defined by the following claims. For example, notwithstanding the fact that the elements of a claim are set forth below in a certain combination, it must be expressly understood that the embodiment includes other combinations of fewer, more, or different elements, which are disclosed herein even when not initially claimed in such combinations.

Thus, specific embodiments and applications of fuel cell integrated system have been disclosed. It should be apparent, however, to those skilled in the art that many more modifications besides those already described are possible without departing from the disclosed concepts herein. The disclosed embodiments, therefore, are not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Insubstantial changes from the claimed subject matter as viewed by a person with ordinary skill in the art, now known or later devised, are expressly contemplated as being equivalent within the scope of the claims. Therefore, obvious substitutions now or later known to one with ordinary skill in the art are defined to be within the scope of the defined elements. The claims are thus to be understood to include what is specifically illustrated and described above, what is conceptually equivalent, what can be obviously substituted and also what essentially incorporates the essential idea of the embodiments. In addition, where the specification and claims refer to at least one of something selected from the group consisting of A, B, C . . . and N, the text should be interpreted as requiring at least one element from the group which includes N, not A plus N, or B plus N, etc.

The words used in this specification to describe the various embodiments are to be understood not only in the sense of their commonly defined meanings, but to include by special definition in this specification structure, material or acts beyond the scope of the commonly defined meanings. Thus, if an element can be understood in the context of this specification as including more than one meaning, then its use in a claim must be understood as being generic to all possible meanings supported by the specification and by the word itself.

The definitions of the words or elements of the following claims therefore include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

What is claimed is:

1. A fuel cell integrated system, comprising:
a main body having a front side, a rear side opposite of the front side, a left side, a right side opposite of the left side, a top side, and a bottom side opposite of the top side, and being supported on a plurality of vertically arranged supporting frames;
an inlet and outlet assembly having an air inlet, a cooling liquid inlet, a hydrogen inlet, a hydrogen outlet, a cooling liquid outlet, and a tail gas outlet arranged on the front side of the main body;
a fuel cell module communicated with the inlet and outlet assembly and arranged on the right side of the main body; wherein
the inlet and outlet assembly comprises a first L-shaped supporting panel and a second L-shaped supporting panel attached to the first L-shaped supporting panel to provide a rectangular supporting panel; wherein
the air inlet, the cooling liquid inlet, and the hydrogen outlet are formed on the first L-shaped supporting panel; wherein
the hydrogen inlet, the cooling liquid outlet, and a tail gas outlet are formed on the second L-shaped supporting panel.

2. The fuel cell integrated system of claim 1, further comprising a fuel cell controller and a low-pressure box arranged on the rear side of the main body.

3. The fuel cell integrated system of claim 1, wherein the first L-shaped supporting panel comprises an air inlet panel affixed on the first L-shaped supporting panel, a cooling liquid inlet panel affixed on the first L-shaped supporting panel, and a hydrogen outlet panel affixed on the first L-shaped supporting panel, wherein the air inlet panel, the cooling liquid inlet panel, and the hydrogen outlet panel are separately and spacedly arranged with each other.

4. The fuel cell integrated system of claim 1, wherein the first L-shaped supporting panel comprises an air inlet panel where the air inlet is formed thereon, an air inlet distribution head attached to the air inlet of the air inlet panel, an air inlet temperature sensor integrated with the air inlet distribution head, an air inlet throttle integrated with the air inlet distribution head, an air inlet switchboard detachably coupled to the air inlet distribution head, and an air inlet filter integrated and affixed with the air inlet switchboard, and an air inlet pressure sensor integrated with the air inlet distribution head.

5. The fuel cell integrated system of claim 1, wherein the first L-shaped supporting panel comprises a cooling liquid inlet panel where the cooling liquid inlet is formed thereon, a cooling liquid distribution head attached to the cooling liquid inlet of the cooling liquid inlet panel, a cooling liquid inlet temperature sensor integrated with the cooling liquid distribution head, a cooling liquid inlet switch board detachably coupled with the cooling liquid inlet distribution head, and a cooling liquid inlet filter affixed with the cooling liquid switchboard.

6. The fuel cell integrated system of claim 1, wherein the first L-shaped supporting panel comprises a hydrogen outlet panel where the hydrogen outlet is formed thereon, a water vapor separator integrated with the hydrogen outlet of the hydrogen outlet panel, and a hydrogen outlet pressure sensor integrated with the water vapor separator.

7. The fuel cell integrated system of claim 1, wherein the second L-shaped supporting panel comprises a hydrogen inlet and cooling liquid outlet panel affixed on the second L-shaped supporting panel, and a tail gas outlet panel affixed on the second L-shaped supporting panel and contacted with the hydrogen inlet and cooling liquid outlet panel.

8. The fuel cell integrated system of claim 1, wherein the second L-shaped supporting panel comprises a hydrogen inlet and cooling liquid outlet panel where the hydrogen inlet and the cooling liquid outlet are formed thereon, a hydrogen inlet distribution head attached on the hydrogen inlet of the hydrogen inlet and cooling liquid outlet panel, a hydrogen inlet temperature sensor integrated with the hydrogen inlet distribution head, a hydrogen inlet filter detachably coupled with the hydrogen inlet distribution head, and a hydrogen inlet pressure sensor integrated with the hydrogen inlet temperature sensor.

9. The fuel cell integrated system of claim 1, wherein the second L-shaped supporting panel comprises a hydrogen inlet and cooling liquid outlet panel, a thermostat attached to the cooling liquid outlet formed on the hydrogen inlet and cooling liquid outlet panel, a cooling liquid outlet pressure sensor integrated with the cooling liquid outlet formed on the hydrogen inlet and cooling liquid outlet panel, and a cooling liquid outlet temperature sensor integrated with the cooling liquid outlet formed on the hydrogen inlet and cooling liquid outlet panel.

10. The fuel cell integrated system of claim 1, wherein the second L-shaped supporting panel comprises a tail gas outlet panel, the tail gas outlet arranged on the tail gas outlet panel, a tail gas throttle integrated with the tail gas outlet, and a tail gas outlet tube coupled with the tail gas throttle in a flange connection.

11. The fuel cell integrated system of claim 1, further comprising a hydrogen recirculation ejector assembly arranged on the front side of the main body and communicated with the inlet and outlet assembly, wherein the hydrogen recirculation ejector assembly comprises an ejector, a fuel cell hydrogen inlet communicated with the ejector and the fuel cell module, a secure valve communicated with the ejector and a proportional valve communicated with ejector.

12. The fuel cell integrated system of claim 1, further comprising a hydrogen buffer valve assembly arranged on the bottom side of the main body and a hydrogen recycle pump arranged on the top side of the main body, wherein the hydrogen buffer valve comprises a buffer tank having a buffer tank left side and a buffer tank right side opposite of the buffer tank left side, a buffer purge valve communicated with the buffer tank and arranged on the buffer tank left side, and a purge valve communicated with the buffer tank and arranged on the buffer tank right side.

13. The fuel cell integrated system of claim 1, further comprising an air compressor arranged on the bottom side of the main body, an intercooler communicated with the air compressor and arranged on the bottom side of the main body, and a plurality of fourth transmission tubes communicated with the air compressor, the intercooler, and the inlet and outlet assembly, wherein the fourth transmission tubes are extended from the bottom side of the main body to the left side of the main body to provide a fuel-air source to the fuel cell module.

14. The fuel cell integrated system of claim 1, further comprising a water pump arranged on the bottom side of the main body, a PTC heater arranged on the bottom side of the main body, and a DC/DC converter for the fuel cell module arranged on the top side of the main body.

15. The fuel cell integrated system of claim 1, further comprising a PTC heater arranged on the bottom side of the main body and a thermostat integrated with the cooling liquid outlet, wherein the thermostat is communicated with the PTC heater through a first transmission tube arranged underneath the inlet and outlet assembly and arranged across the inlet and outlet assembly.
